(19) United States
(12) Patent Application Publication
(10) Pub. No.: US 2012/0228808 A1
(43) Pub. Date: Sep. 13, 2012

(54) METHOD FOR MANUFACTURING HOUSINGS

(76) Inventor: Sheng-Yu Tsai, (US)

(21) Appl. No.: 13/043,065

(22) Filed: Mar. 8, 2011

(51) Int. Cl. B29C 45/14

(52) U.S. Cl. 264/510

(57) ABSTRACT

A method for manufacturing a housing is provided. A fiber film is placed on a first mold, and a second mold presses the fiber film to make it deform slightly. When the first mold and the second mold are not closed completely, the melt plastic material is injected from the second mold to the fiber film to press down the fiber film. Then, the molds are assembled while the melt plastic material is injected to form a molding product. Furthermore, the edge of the fiber film near the corner is cut off to obtain a housing with a well-attached fiber film.

### BACKGROUND OF THE INVENTION

1. Field of the Invention

The invention relates to a method for manufacturing a housing and, more particularly, to a method for manufacturing a housing having a fiber film.

2. Description of the Related Art

In recent years, electronic devices are tending to have housings made of natural materials to replace conventional cold and hard plastic or metal housings. Among the natural materials, bamboo and wood are particularly noticed. Except for special longitudinal fiber traces, it is favored by many Europeans and Americans due to the oriental verve.

However, unlike the conventional fiber, plastic or metal, the bamboo material is not easily manufactured. For mass production, the manufacturers usually follow the in-mold injection method to put the bamboo material in the mold, inject the plastic material, and form a plastic housing covered by bamboo.

In order to make the bamboo manufactured in the mold successfully, many methods are provided. However, the bamboo material has poor stretchability and flexibility. Thus, when it is used at a curve housing or a bended corner, the bamboo material is hard to attach to the plastic housing flatly, and it is easy to be squeezed, stacked, deformed or even cracked, resulting in appearance imperfections.

To solve the problem, in a conventional method, the bamboo material is soaked before manufacture, and it is easier to be attached to the housing. However, bamboo fibers naturally have no flexibility to be stretched, and the mentioned problems still happen on a curve surface or at a corner. Another method is to curve or to form corners of the bamboo material by cutting, and then the bamboo is pressed to deform to a desired shape. However, the density of the bamboo material changes due to the pressing, and the appearance is also affected.

### BRIEF SUMMARY OF THE INVENTION

The invention provides a method for manufacturing a housing. First, placing a fiber film on a first mold with a mold cavity, and the area of the fiber film is larger than that of the mold cavity; Second, moving a second mold towards the first mold, injecting the melt plastic material onto the fiber film through a second mold, pushing the fiber film towards the mold cavity until the mold cavity is filled with the melt plastic material and a molding product is formed; after cooling, taking out the molding product, cutting off the edge of the fiber film at the corner of the molding product, and a housing structure covered with bamboo is completed. In other words, the melt plastic material is injected before the first mold and the second mold is matched, thus to press the central part of the fiber film for positioning. The method avoids the wrinkles of the fiber film occurring at the curved corner in the molding process.

For positioning, the fiber film is attached by vacuum via the second mold when the second mold contacts with the fiber film. When the fiber film is attached slightly, the melt plastic material is injected, and at the same time, the vacuumizing is stopped. Moreover, the second mold can also be used to press the fiber film to deform and contact with the bottom of the mold cavity of the first mold, then the melt plastic material is injected to press and position the fiber film.

These and other features, aspects and advantages of the present invention will become better understood with regard to the following description, appended claims, and accompanying drawings.

### BRIEF DESCRIPTION OF THE DRAWINGS

FIG. 1A to FIG. 1E are schematic views showing the steps of a method for manufacturing a housing of the invention;

FIG. 2A to FIG. 2C are schematic views showing the first embodiment of the method for manufacturing a housing of the invention;

FIG. 3A to FIG. 3B are schematic views showing the second embodiment of the method for manufacturing a housing of the invention; and

FIG. 4A to FIG. 4B are schematic views showing post-processing for a molding product manufactured by the method of the invention.

### DETAILED DESCRIPTION OF THE EMBODIMENTS

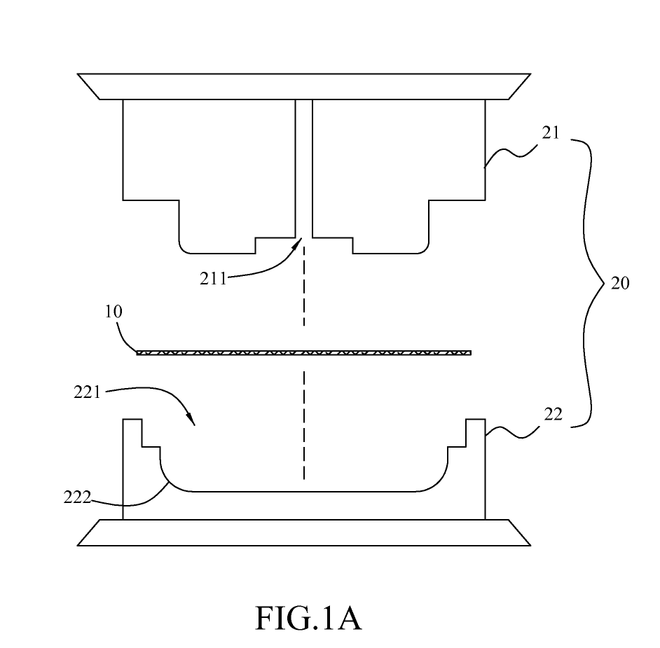

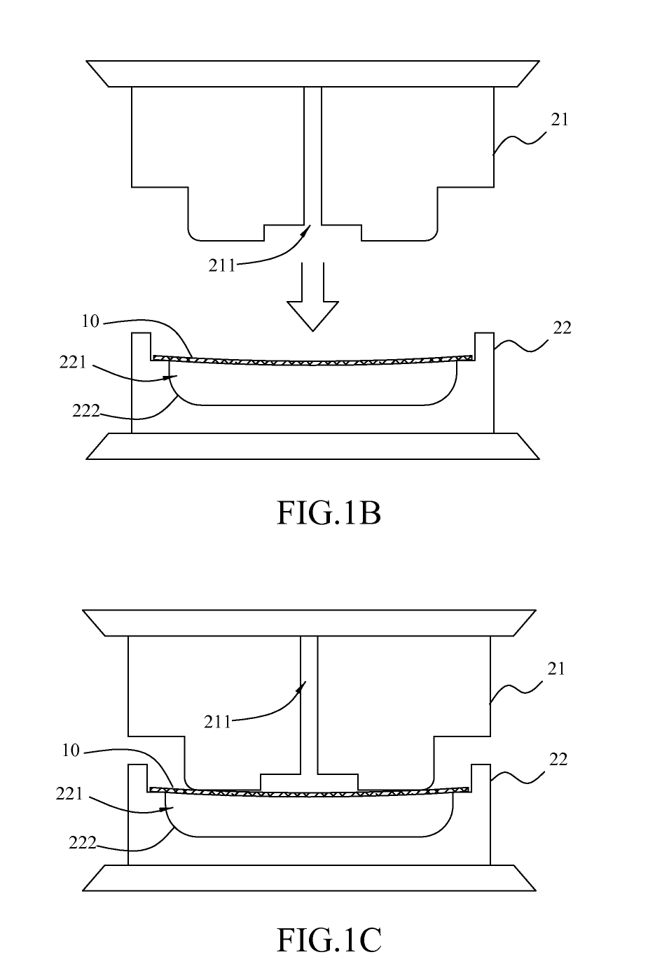

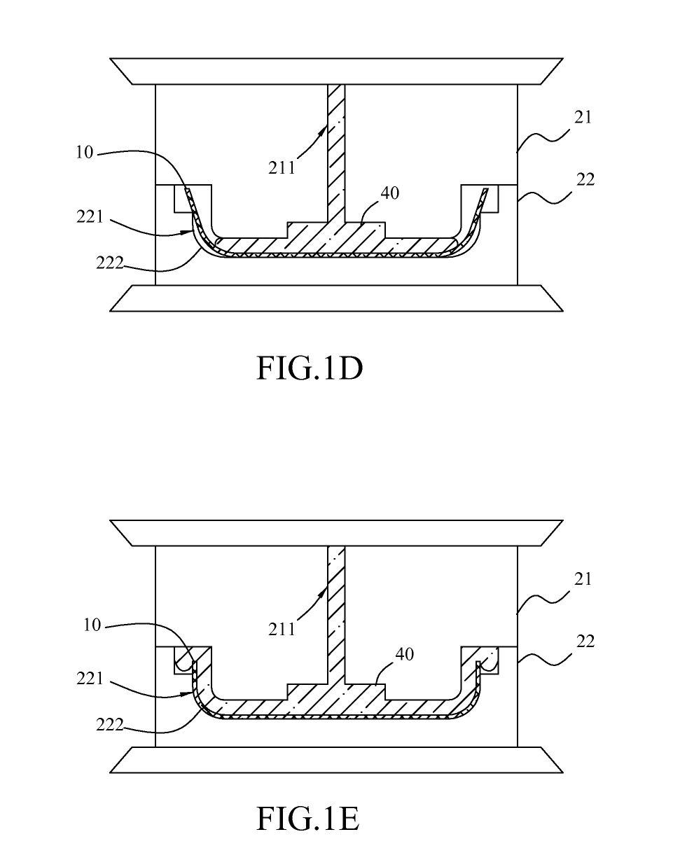

As shown in FIG. 1A to FIG. 1E, the steps for manufacturing a housing is provided.

First, a fiber film 10 and a mold 20 are provided. The fiber film 10 may be various natural fiber materials such as bamboo or wood. Taking the bamboo as an example, after cutting, slitting, rough planing, carbonization, drying, fine planing, coating glue, pressing to sheet, stewing, combining to bamboo sheet, drying and punishing, sanding, cutting and other processes, the bamboo laminate sheet is obtained for further processing.

The mold 20 includes a second mold 21 and a first mold 22. The first mold 22 includes a depressed cavity 221, and the second mold 21 includes a protrusion corresponding to the cavity 221. When the second mold 21 and the first mold 22 are matched, the mold cavity 221 is sealed for injection.

In FIG. 1B, the fiber film 10 is placed on the first mold 22. As shown in FIG. 1B, since the fiber film 10 is to cover all of the structure when the structure is molded, the area of the fiber film 10 is larger than that of the mold cavity 221, and the fiber film 10 covers the mold cavity 221 and does not contact with the bottom of the mold cavity 221. In another example, when the mold product only has a corner 222 at one side, the area of the fiber film 10 is smaller than that of the mold cavity 221 to make the fiber film 10 only contact with a part of the mold cavity 221.

In FIG. 1C, the second mold 21 is moved towards the first mold 22 to make the bottom of the second mold 21 contact with the fiber film 10, and the second mold 21 presses the fiber film 10 to make the fiber film 10 deform towards the bottom of the mold cavity 221 of the first mold 22. Before the second mold 21 and the first mold 22 are matched, the melt plastic material is injected into the fiber film 10 to press and fix the fiber film 10. Two embodiments are provided herein to illustrate the invention.

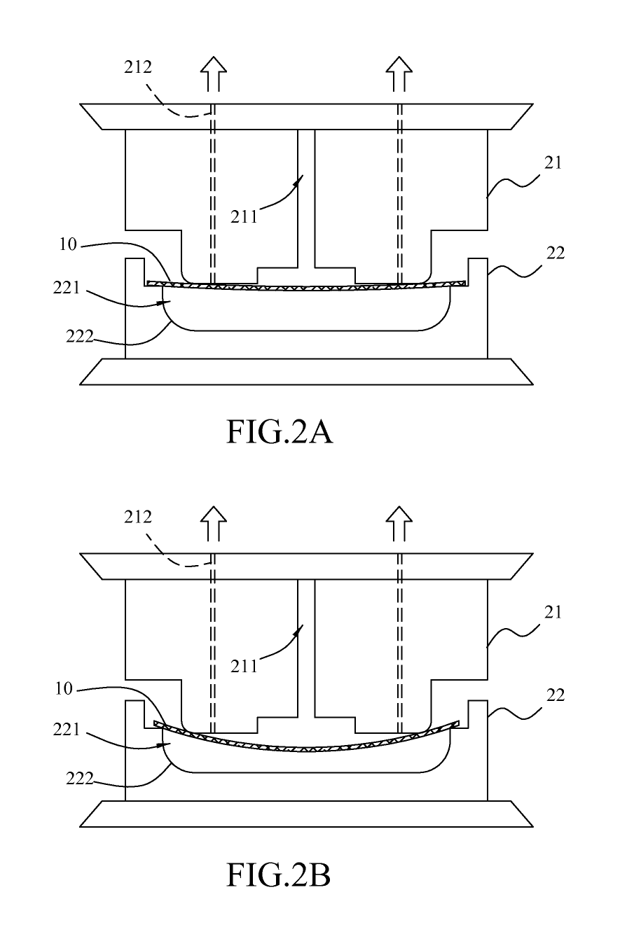

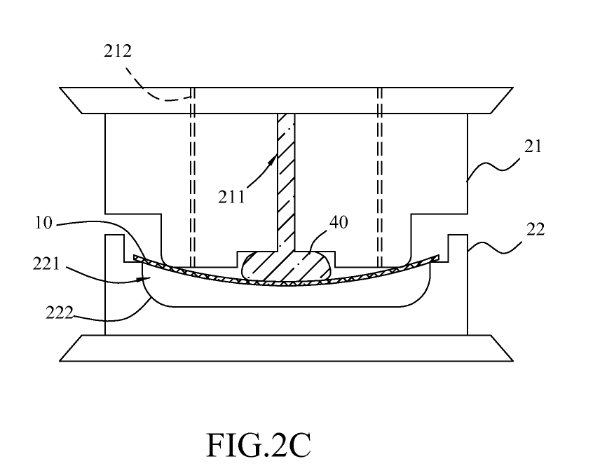

FIG. 2A to FIG. 2C are schematic diagrams showing the steps of fixing and injecting a fiber film of the method for manufacturing a housing in a first embodiment of the invention. The second mold 21 includes a plurality of vacuum suction holes 212 which are different from that in a conventional mold. Conventionally, in an in-mold process, the needed vacuum suction holes are usually formed at the first mold. However, if the fiber film 10 is positioned by vacuumizing process via the first mold, the bamboo sheet may be squeezed, stacked, deformed or even cracked since the fiber film 10 has no flexibility.

In the embodiment, the vacuum suction holes 212 are formed at the second mold 21. When the second mold 21 contacts with the fiber film 10, the fiber film 10 is attached to the bottom of the second mold 21 by vacuum via the vacuum suction holes 212, and then the second mold 21 is used for pressing the fiber film 10 to make it deform slightly (as shown in FIG. 2B).

As shown in FIG. 2C, before the second mold 21 and the first mold 22 are matched, the melt plastic material 40 is approximately injected into the central part of the fiber film 10 through a sprue gate 211. The weight of the melt plastic material 40 presses the central part of the fiber film 10 to position the fiber film 10. When the melt plastic material 40 is injected, the vacuumizing process is stopped to avoid leaving a trace, caused by the vacuum suction holes 212, on the product.

While the second mold 21 is moved towards the first mold 22, the melt plastic material 40 is injected continuously until the first mold 22 and the second mold 21 are matched, as shown in FIG. 1D. Since the fiber film 10 is not fixed completely on the mold cavity 221 of the first mold 22 while injection, the melt plastic material 40 flows through the central part to press and position the fiber film 10, and the melt plastic material 40 is injected continuously and flows towards the two sides of the fiber film 10 (as shown in FIG. 2C, the melt plastic material 40 flows towards two sides of the fiber film 10, in fact, it flows towards all sides). The fiber film 10 is flattened from the center to all sides of the mold cavity 221 of the first mold 22. Finally, in FIG. 1E, the mold cavity 221 is filled with the melt plastic material 40.

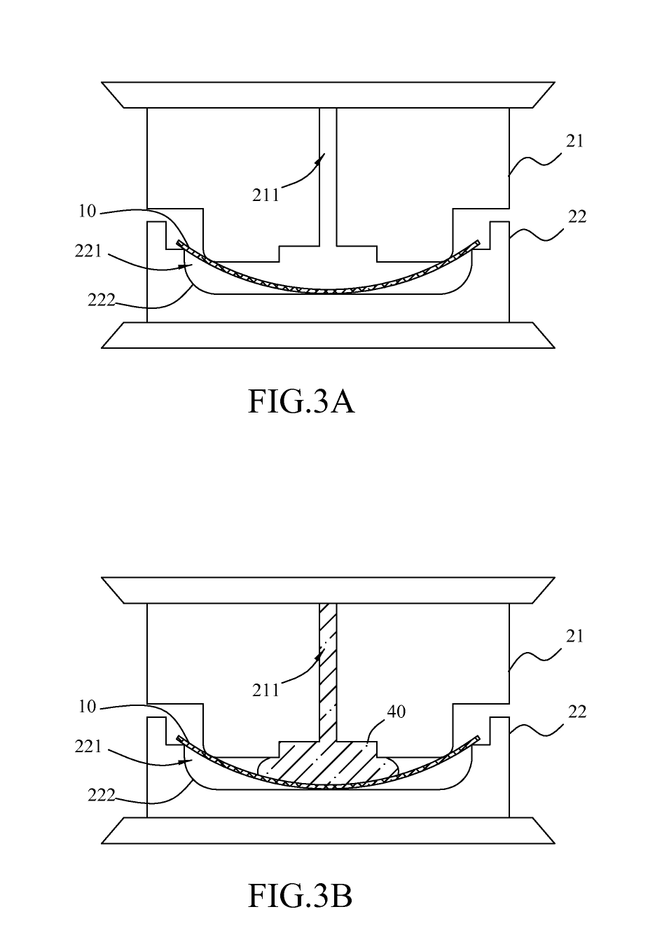

On the other hand, except for the vacuumizing method in the first embodiment above, FIG. 3A to FIG. 3B are schematic diagrams showing the steps of fixing and injecting a fiber film of the method for manufacturing a housing in a second embodiment of the invention. When the second mold 21 contacts with the fiber film 10, it presses the fiber film 10 directly and keeps moving to make the fiber film 10 deform until the fiber film 10 contacts with the bottom of the mold cavity 221 of the first mold 22 (as shown in FIG. 3A). Then, the melt plastic material 40 is injected through the sprue gate 211 of the second mold 21 (as shown in FIG. 3B).

Similarly, at the beginning of the injection, the second mold 21 and the first mold 22 are not matched, and the melt plastic material 40 is injected and approximately flows to the central part of the fiber film 10 for pressing and fixing the fiber film 10. Afterwards, the second mold 21 also moves towards the first mold 22, and the melt plastic material 40 is injected continuously until the second mold 21 and the first mold 22 are matched (as shown in FIG. 1D). Finally, the mold cavity 221 is filled with the melt plastic material 40 (as shown in FIG. 1E).

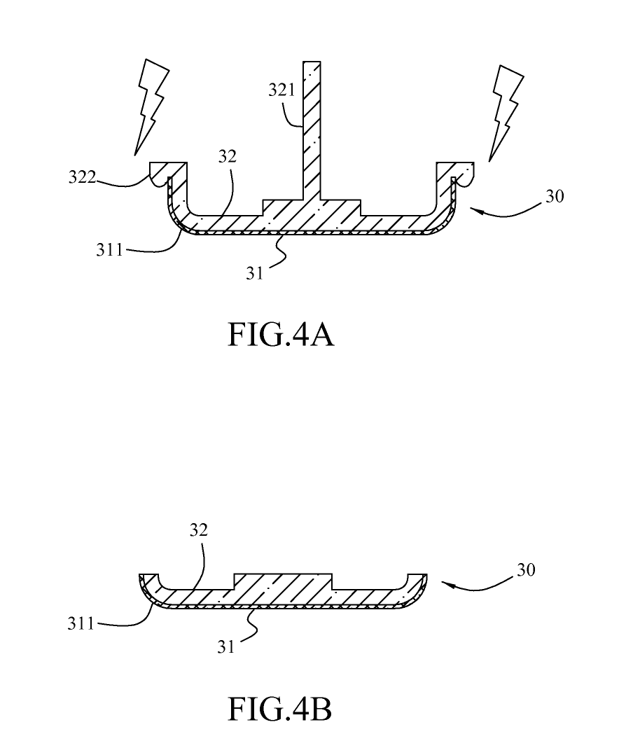

After a molding product 30 is cooled down, the finished molding product 30 is taken out. As shown in FIG. 4A, the molding product 30 includes a fiber film layer 31 and a plastic layer 32. Cut off the scraps 321 of the plastic layer 32 between the second mold 21 and the sprue gate 211 as well as the edges of a curve surface (the corner 311 in FIG. 4A) of the fiber film layer 31 and the scrap 322 of the plastic layer 32. A housing structure with a well-attached bamboo cover is obtained (as shown in FIG. 4B).

Since the fiber film 10 is not an elastic material and cannot be stretched, even by injecting the melt plastic material 40 from the center to the sides, the edges of a curve surface still have some squeezes, stacks, or deformations. Thus, a larger fiber film 10 is provided, and the edges of the curve surface are cut off after the molding, and then a well-attached curve surface with a smooth corner is finished. As shown in FIG. 4A, the curve surface is the corner 311. The method can also be applied in other three dimensional (3D) curve surfaces, and the same effect is also achieved.

According to a method for manufacturing a housing in the invention, the second mold is used for vacuumizing to position the fiber film, and then the melt plastic material is injected and presses down the fiber film, or the fiber film is pressed directly until it deforms and contacts with the bottom of the mold cavity. Before the second mold and the first mold are matched, the melt plastic material is injected through the second mold from the central part of the fiber film to all sides to close the molds and finish the injection molding, and then the edges of the curve surface of the molding product are cut off. Finally, a housing structure with a well-attached fiber film is finished.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A method for manufacturing a housing, comprising:
placing a fiber film on a first mold having a mold cavity, wherein the area of the fiber film is larger than the area of the mold cavity;
moving a second mold towards the fiber film;
providing melt plastic material flowing through the second mold to push the fiber film towards the mold cavity and fill the mold cavity melt plastic material to obtain a molding product; and
cutting an edge of the fiber film at a corner of the molding product.

2. The method for manufacturing the housing according to claim 1, wherein the second mold presses the fiber film to deform the fiber film and contact with a bottom of the mold cavity of the first mold.

3. The method for manufacturing the housing according to claim 2, wherein the fiber film is pressed down by the melt plastic material.

4. The method for manufacturing the housing according to claim 1, wherein the molding product includes a fiber film layer and a plastic layer.

5. The method for manufacturing the housing according to claim 1, wherein in the step of cutting the edge of the fiber film at the corner of the molding product, the edge adjacent to the corner of the fiber film layer and scraps of the plastic layer are cut off.

6. The method for manufacturing the housing according to claim 1, wherein the fiber film is made of a natural fiber material such as bamboo or wood.

7. The method for manufacturing the housing according to claim 1, wherein the second mold includes a suction hole and the fiber film is attached by vacuum via the second mold.

8. The method for manufacturing the housing according to claim 1, wherein the second mold further includes a sprue gate.
